(19) United States
(12) Patent Application Publication
(10) Pub. No.: US 2024/0119378 A1
(43) Pub. Date: Apr. 11, 2024

(54) SYSTEM AND METHOD FOR MONTHLY REVENUE COMMIT COST OPTIMIZATION

(71) Applicant: TUBE, Inc., D/B/A Reach Mobile, Chelmsford, MA (US)

(72) Inventors: Shantigram Venkatesh Jagannath, Chelmsford, MA (US); Harsh Saxena, Chelmsford, MA (US); Kuna Hanuma, Chelmsford, MA (US); Avi Chopra, Chelmsford, MA (US)

(73) Assignee: TUBE, Inc., D/B/A Reach Mobile, Chelmsford, MA (US)

(21) Appl. No.: 18/377,358

(22) Filed: Oct. 6, 2023

Related U.S. Application Data
(60) Provisional application No. 63/413,673, filed on Oct. 6, 2022.

(51) Int. Cl. G06Q 10/0631; G06Q 10/04

(52) U.S. Cl. CPC G06Q 10/06313; G06Q 10/04

(57) ABSTRACT

Disclosed are systems and methods for monthly revenue commit (MRC) cost optimization, for virtual network operators whose customers utilize a network operated by a different network operator. The disclosed generally involves four stages: 1) onboarding and initial wholesale plan selection; 2) estimating what a customer's requirements (e.g., data usage) are likely to be for a month; 3) determining the least-cost wholesale plan the customer should be placed on; and 4) switching the customer's wholesale plan.

### CROSS-REFERENCE TO RELATED APPLICATIONS

The present application claims priority to U.S. Provisional Patent Application 63/413,673, filed Oct. 6, 2022, the contents of which are incorporated by reference herein in its entirety.

### TECHNICAL FIELD

The present disclosure is drawn to systems and techniques for, e.g., reducing overpayments to network operators (e.g., mobile network operators such as T-Mobile, AT&T, etc.) from virtual network operators whose customers have erroneous wholesale plans.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

For customers using virtual network operators, each customer selects their own retail plan, which then allows them a certain limit of data usage. The customer is free to use as much data within this limit or purchase additional data packs if they wish to exceed the limit. Behind the scenes, the customer is mapped to a wholesale plan provided by a mobile network operator (MNO). The wholesale plan has a monthly committed cost and has its own limit for data usage, and an overage charge if the customer exceeds the wholesale plan data limit.

Historically, there are lot of customers with erroneous wholesale plan configurations—in particular, they are mapped to a wholesale plan with a much lower usage limit (e.g., lower data, voice, and/or text limits) than the retail plan. This is leading to very heavy losses due to overage payments to the MNO. There are also a lot of customers whose wholesale plan has a substantially higher usage limit than the retail plan, which results in unnecessarily paying more to the MNO.

### BRIEF SUMMARY

Various deficiencies in the prior art are addressed below by the disclosed compositions of matter and techniques.

In various aspects, a method for monthly revenue commit cost optimization may be provided. The method may include receiving a selection of a retail plan by a customer. The method may include selecting an initial wholesale plan offered by a network operator for use of a network. The method may include mapping the initial wholesale plan to the retail plan of the customer. The method may include receiving usage of the network by the customer for a first period of time. The method may include estimating a future monthly usage of the network by the customer. The method may include determining a least-cost wholesale plan for the customer. The method may include switching (including, e.g., automatically switching) the customer from the initial wholesale plan to the least-cost wholesale plan. The method may include mapping (including, e.g., automatically mapping) the least-cost wholesale plan to the retail plan.

Estimating future monthly usage of the network may include determining which of a plurality of categories the customer belongs in based on a number of days since the initial wholesale plan was mapped to the retail plan. Estimating future monthly usage of the network may include determining whether the customer is in a pooled plan or a non-pooled plan.

Estimating future monthly usage may occur at any time. In some embodiments, it may occur at least one time per day.

Determining the least-cost wholesale plan may include determining a pool adjustment factor (PAF). Determining the least-cost wholesale plan may include comparing the cost of a plan having a lower allocation than the estimated future monthly usage and overage costs based on the estimated future monthly usage to the cost of a plan having a higher allocation than the estimated future monthly usage. Determining a least-cost wholesale plan for the customer may include generating a plurality of cost datapoints utilizing multiple cost functions to estimate both individual and the overall wholesale cost.

Generating a plurality of cost datapoints may be done at any time. In some embodiments, it may be done daily. In some embodiments, it may be done monthly.

In various aspects, a system for monthly revenue commit cost optimization may be provided. The system may include one or more processors, and a non-transitory computer-readable storage medium containing instructions that, when executed, configure the one or more processors to, collectively, perform an embodiment of the method disclosed herein.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a block diagram illustrating the mapping of retail and wholesale plans.

FIG. 2 is a flowchart of a method.

FIG. 3 is a flowchart of a portion of a method relating to data usage estimation and wholesale plan selection.

FIG. 4 is a block diagram of a system.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Disclosed are systems and techniques that utilize a MRC (monthly revenue commit) Cost Optimization (MCO) algorithm, that attempts to minimize the cost incurred on the wholesale plans by taking advantage of variance and lower usage of data by customers who do not typically use their full allowance. The selection of the wholesale plan determines the MRC cost for the customer to be paid to the MNO. Many customers can benefit from genuine MCO, as their actual data usage is below the current wholesale plan selected. Substantial savings can result by automatically controlling the selection and mapping of the retail plan to the wholesale plans.

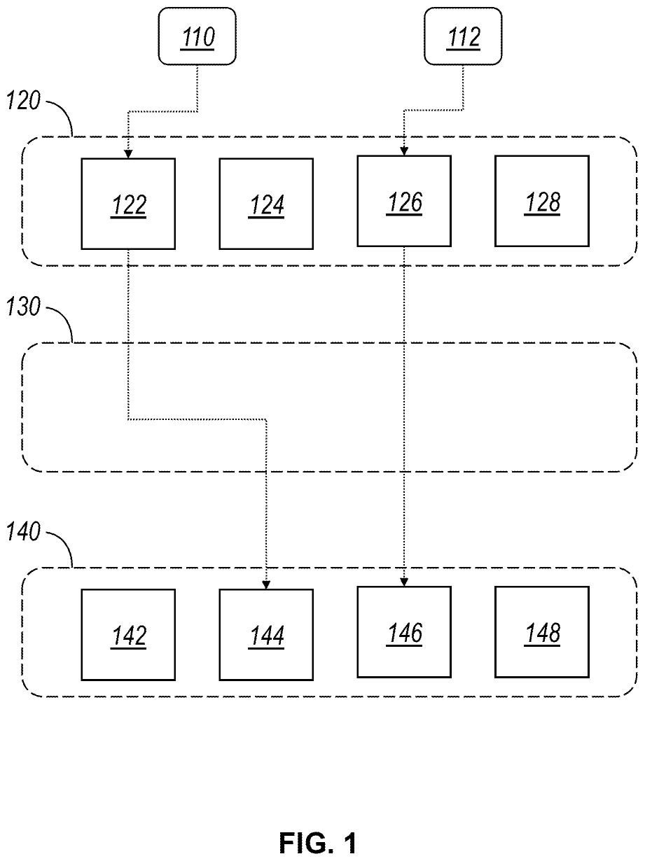

Referring to FIG. 1, users (e.g., first user 110 and second user 112) may make initial selections of a retail plan 122, 124, 126, 128 offered by a retailer (such as a mobile virtual network operator (MVNO)) 120. The different retail plans typically have different monthly plan costs, different data usages, different voice usages, and/or different text usage limits.

There is a mapping process 130 that maps the retail plan to a wholesale plan 142, 144, 146, 148 offered by a wholesaler (such as an MNO) 140. In FIG. 1, retail plan 122 selected by a first user 110 was mapped to wholesale plan 144, while retail plan 126 selected by second user 112 was mapped to wholesale plan 146. The wholesale plans, like the retail plans, typically have different monthly plan costs, different data usages, different voice usages, and/or different text usage limits, and also may have various overage rates when these limits are exceeded.

To avoid some of the problems with conventional retail/wholesaler mapping, the disclosed methods may involve multiple stages. These stages may be performed by one or more processors, e.g., on one or more cloud-based servers operably connected to various databases, that collectively perform the various steps.

A first stage is onboarding and initial wholesale plan selection.

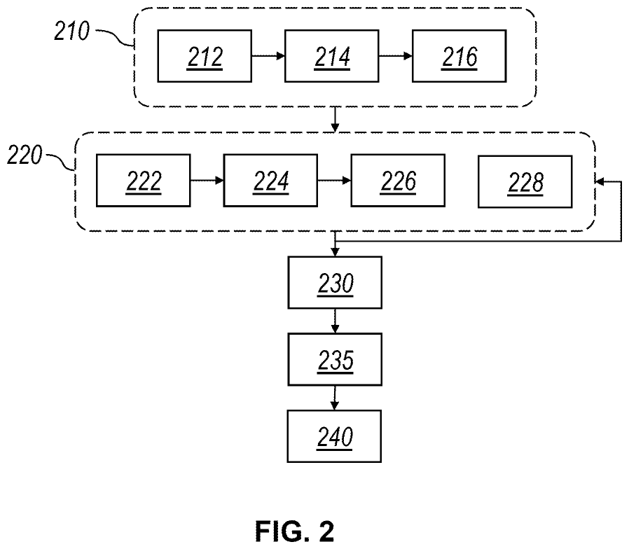

Referring to FIG. 2, in some embodiments, the onboarding process 210 may involve gathering 212 data related to the customer, which may include gathering demographic information about the user. Non-limiting examples of demographic parameters include, e.g., age, location, and social media choices, and/or video streaming subscriptions. In some embodiments, these parameters may be used to form a preliminary estimate of what the customer is likely to use.

In some embodiments, onboarding may include receiving 214 a customer's selection of a retail plan.

After selecting a retail plan, the method may include selecting 216 an initial wholesale plan from a number of plans that are offered by a network operator. This selection may occur in a variety of ways, and may use the data collected to this point (e.g., demographics, customer's selection of a retail plan, etc.). In some embodiments, the initial wholesale plan is selected as a wholesale plan that is closest to the selected retail plan. The initial wholesale plan may be a wholesale plan that has one or more lower usage limits (e.g., data, voice, text) than the selected retail plan. The initial wholesale plan may be a wholesale plan that has one or more higher usage limits than the selected retail plan. Once selected, the initial wholesale plan may be mapped to the retail plan of the customer.

In some embodiments, the selection may be based on whether the customer is in a pooled or non-pooled plan, and may further be based on the number of people in a pooled plan. For example, for an individual non-pooled plan, the method may include selecting a wholesale plan that matches the retail plan the closest. For pooled plans, the method may include selecting the wholesale plan immediately lower than the retail plan. Risk on a pooled plan is evened out with larger number of customers on a pooled plan, so one can pick a lower plan with lower assumed risk.

A second stage is estimating what the user/customer requirements (e.g., data usage) are likely to be for a period of time (such as a month of time). Estimating a user's requirements for this period of time can then be done using any appropriate technique. In some embodiments, the customer may be a single, standalone user. In some embodiments, the customer may be one member of a pool of users.

In some embodiments, the calculation for expected usage for each user may be based on the number of days' worth of usage data is available for that user. Therefore, in some embodiments, estimating 220 requirements may include determining 222 the number of days' worth of usage data that is available for the user. Further, in some embodiments, users may then be placed 224 into one category of a plurality of categories based on available days of usage data, such as Category 1: <30 days of usage data, Category 2: 30-45 days, Category 3: 45-90 days, or Category 4: >90 days.

In some embodiments, the estimating process may include determining and/or using a first statistical measure (e.g., cumulative usage data) over a first fixed period of time (e.g., 30 days), a second statistical measure (e.g., mean usage data) over a second fixed period of time (e.g., 7 days), and/or a third statistical measure (e.g., standard deviation of usage data) over a third fixed period of time (which may be, e.g., 7 days, 14 days, etc.).

In some embodiments, the estimation may take real-world situations, such as weather events, social events, etc., into account when determining future usage. For example, if it is known that a winter storm shut down power to a city for a week, the reported usage may be different from what would be expected normally, and the estimation may take such events into account to modify estimates based on actual usage data. Similarly, different seasons may have different usage patterns for a given user. For example, a user may use more data during winter months than during summer months.

Each user's estimations may independently be done at any frequency. In some embodiments, this frequency may be fixed. In some embodiments, the method may include adjusting 228 the update frequency. In some embodiments, the frequency is controlled by the user (that is, in some embodiments, the method may include receiving input from the user relating to the update frequency). In some embodiments, estimations can be made daily, weekly, monthly, or any combination thereof. In some embodiments, estimations may be made daily. In some embodiments, estimations may be made weekly. In some embodiments, estimations may be made every two weeks. In some embodiments, estimations may be made monthly. In some embodiments, the frequency is controlled by the MVNO.

### Example 1—Estimating the Monthly Usage for a User

To estimate the monthly usage, a distribution for the monthly data usage for each user may be approximated, and that distribution may then be used to estimate an expected value. Using the distribution, one can estimate a value for data usage which affords a predetermined probability (e.g., a probability of 0.68). This value is related to the risk of overusage.

In some embodiments, the predetermined probability may be at least 0.5. In some embodiments, the predetermined probability may be at least 0.55. In some embodiments, the predetermined probability may be at least 0.6. In some embodiments, the predetermined probability may be at least 0.65. In some embodiments, the predetermined probability may be at least 0.66. In some embodiments, the predetermined probability may be no more than 0.95. In some embodiments, the predetermined probability may be no more than 0.9. In some embodiments, the predetermined probability may be no more than 0.85. In some embodiments, the predetermined probability may be no more than 0.8. In some embodiments, the predetermined probability may be no more than 0.75. In some embodiments, the predetermined probability may be no more than 0.7.

Initially, without a distribution and the mapping, one can assume it is a normal distribution and pick an error factor for the expected value to reduce risk of overage.

In some embodiments, to calculate the mean:
1. Have a running count of the last 30 days cumulative usage for the user, taken over last 90 days (“CD30”).
2. Use the last 7 values (one week) of CD30 to estimate the mean (“M_CD30”) and the standard deviation (“S_CD30”) for CD30.

Since CD30 is a cumulative for last 30 days, it already has the benefit of being a smooth variable. Taking the last 7 days gives the benefit of capturing the most recent variances.

In some embodiments, to estimate the expected monthly usage (“E30”) for a user on a non-pooled plan:
1. For a new user (e.g., less than 1 month of historical data), E30 should be the same as the user-selected retail plan.
2. For a user with less than 45 days of historical data, E30=M_CD30+S_CD30.
3. For a user with 45-90 days of historical data, E30=M_CD30+(0.75 S_CD30).
4. For a user with more than 90 days of historical data, E30=M_CD30+(0.5 S_CD30).

In some embodiments, to estimate the expected monthly usage (“E30”) for a user on a non-pooled plan:
1. For new users E30 will be set to the retail plan.
2. For user with at least 45 days of historical data, E30=M_CD30 as calculated for the user.

With pooled plans, all users on a pooled plan combine their data usage, hence there is statistical averaging. Further, pooled plans may be enforced on a daily average basis, so it is possible to make decisions daily and influence the cost.

A third stage of the method may be determining the least-cost wholesale plan the user(s)/customer(s) should be placed on. More specifically, once the monthly requirements are estimated, the system and method can then determine 235 an appropriate wholesale plan for the user(s).

In some embodiments, the determination may include consideration of the cost of the plans and overage costs relative to the expected monthly requirement. For example, in some embodiments, while a user may be predicted to use more data than a first wholesale plan allows, the cost of a higher-usage second wholesale plan may be more expensive than paying for the lower-usage first wholesale plan and any associated overage costs.

In some embodiments, the determination may include consideration of the variability of the user's usage patterns. If the variability of a user's usage is high, it may be beneficial to select a higher-usage wholesale plan than would otherwise be predicted.

In some embodiments, the method may include calculating 230 a pool adjustment factor (PAF) for each plan. In some embodiments, the user plan selections are adjusted to keep PAF as close to 1 as possible. In some embodiments, one or more thresholds may be used to determine whether a change to a different wholesale plan makes sense for a given user. For example, the system or method may evaluate the risk or probability of one or more customers exceeding their expected monthly estimates, and if that risk or probability is above a certain threshold, it may trigger a modification to one or more customers' plans.

### Example 2—Selecting Wholesale Plans

In some embodiments, rules for setting the wholesale plan for non-pooled users include:
1. Using the E30 value from the previous step to select the user wholesale plan.
2. The wholesale plan for the user should be set to either the nearest plan lower or equal to E30 (“L_E30”) or the nearest plan higher than E30 (“H_E30”). The decision to select Low or High may depend on the plan cost (“Cost_low”, “Cost_high”) and the overage cost (“cost_overage”). For example, in some embodiments, the formula to be used is: If Cost_low+cost_overage*(E30−L_E30)<Cost_High: select L_E30; else select H_E30.

In this scenario, a new user will never be placed in a wholesale plan that is lower than L_E30.

In some embodiments, rules for setting the wholesale plan for pooled users include:
1. Use the E30 value from above to select the user wholesale plan
2. Define a separate pool adjustment factor (PAF) for each plan. The PAF is a factor that allows taking the benefit of the pooled plan. To start with for a pooled plan the PAF may be set to 1. PAF is adjusted daily based on the total plan usage (“PD30”). PAF may be the ratio of the PD30 to the allowed data usage on the plan based on daily averages of users (“WPD30”). In some embodiments, PAF=PD30/WPD30. In some embodiments, PAF may be calculated daily and used for user decisions daily. The objective will be to keep PAF as close to 1 as possible to have most effective utilization of the plans.
3. The wholesale plan for the user should be set to either the nearest plan lower or equal to E30*SQRT(PAF) (“LP_E30”), or the lowest plan available. If the actual total usage is lower cumulatively, then the E30 is automatically adjusted by the PAF. For example, if the actual usage is 2 TB and the overall wholesale plan is allocated 2.5 TB, the PAF value will be 0.8, and all the user plan selections will automatically be pushed down where possible. It is possible that the algorithm might lead to oscillation of PAF around the value 1. It is safer to use SQRT(PAF). However, the algorithm will be a bit slower in reacting to changes.

In some embodiments, pooled plan decision may be made daily. For example, in some embodiments, plan changes may be made at 12:01 AM on the day of the change—either upgrade or downgrade. Depending on the pooled plan rules, that may be the best time to change.

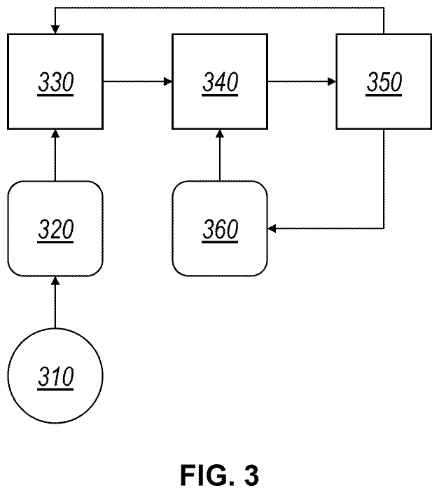

An embodiment of the second and third stages can be seen with respect to FIG. 3. In FIG. 3, actual usage 310 feeds into a historical data model 320. The historical data model is connected to a data usage estimator 330. Output from the data usage estimator feeds into a cost estimator 340, the output of which is then used by a wholesale plan selector 350. The wholesale plan selector then connects to an actual cost model 360, which can then be used by the cost optimizer 340 in combination with data from the data usage estimator 330. Output from the wholesale plan selector also connects to the data usage estimator 330.

The fourth stage may be switching the customer's wholesale plan.

After the wholesale plans are determined, the system and method may be configured to switch 240 the customer to the optimal wholesale plan. This may happen in the backend and may be transparent to the customer. For example, the customer may continue to see the same retail plan, but may be mapped to a different wholesale plan.

In some embodiments, the disclosed technique may include additional functions. For example, in some embodiments, the system and method may utilize multiple cost functions to estimate both the individual and the overall wholesale cost, either per day or per month. Such cost functions are used to do a what-if cost calculation, using the decision output of the monthly revenue commit (MRC) cost optimization process. The cost estimations can be what is used to make decisions and do cost optimizations. Thus, in some embodiments, the cost calculation is not a straightforward summation of costs, but rather, may be a collection of functions that may be used to generate a number of cost data-points, and decisions can be made based on those cost data-points.

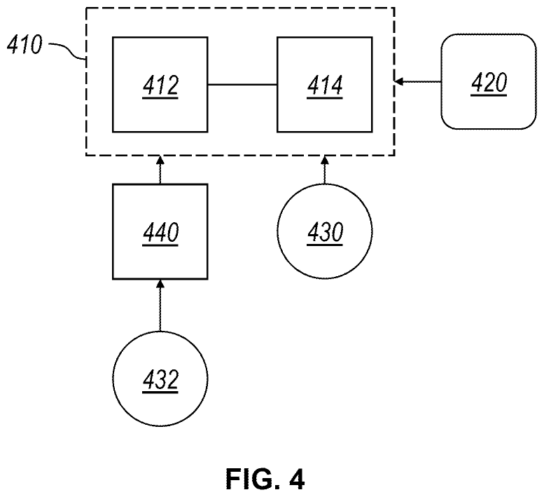

Referring to FIG. 4, a system may be seen. The system may include one or more processors 412. The system may include a non-transitory computer-readable storage medium 414 containing instructions that, when executed, configure the one or more processors to perform a method for monthly revenue commit cost optimization as disclosed herein. The one or more processors may be on a single device 410 (such as a cloud-based server), or may be on multiple devices. The system may receive information from a wholesale MNO 420. The information may include details relating to wholesale plans offered by the MNO. The device(s) 410 of the system may receive information from devices belonging to a user (such as first user device 430 or a second user device 432). The information may be received directly (e.g., first user device 430 is shown communicating directly with device 410) or indirectly (e.g., second user device 432 is shown communicating with device 410 via an intermediate retailer processor 440). For example, the one or more processors 412 may include an application programming interface (API) that may allow multiple retailers to communicate with the one or more processors. In this way, the one or more processors may be shielded from any user-identifying information, and can minimize any privacy concern of a retailer.

Various modifications may be made to the systems, methods, apparatus, mechanisms, techniques, and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed:

1. A method for monthly revenue commit cost optimization, comprising:
receiving a selection of a retail plan by a customer;
selecting an initial wholesale plan offered by a network operator for use of a network and mapping the initial wholesale plan to the retail plan of the customer;
receiving usage of the network by the customer for a first period of time;
estimating a future monthly usage of the network by the customer;
determining a least-cost wholesale plan for the customer; and
switching the customer from the initial wholesale plan to the least-cost wholesale plan and mapping the least-cost wholesale plan to the retail plan.

2. The method according to claim 1, wherein estimating future monthly usage of the network includes determining which of a plurality of categories the customer belongs in based on a number of days since the initial wholesale plan was mapped to the retail plan.

3. The method according to claim 1, wherein estimating future monthly usage of the network includes determining whether the customer is in a pooled plan or a non-pooled plan.

4. The method according to claim 1, wherein estimating future monthly usage at least one time per day.

5. The method according to claim 1, wherein determining the least-cost wholesale plan includes determining a pool adjustment factor (PAF).

6. The method according to claim 1, wherein determining the least-cost wholesale plan includes comparing: (i) a cost of a plan having a lower allocation than an estimated future monthly usage and overage costs based on the estimated future monthly usage to (ii) a cost of a plan having a higher allocation than the estimated future monthly usage.

7. The method according to claim 1, wherein determining a least-cost wholesale plan for the customer includes generating a plurality of cost datapoints utilizing multiple cost functions to estimate both individual and an overall wholesale cost.

8. The method according to claim 7, wherein generating a plurality of cost datapoints is done daily.

9. The method according to claim 7, wherein generating a plurality of cost datapoints is done monthly.

10. A system for monthly revenue commit cost optimization, comprising:
one or more processors; and
a non-transitory computer-readable storage medium containing instructions that, when executed, configure the one or more processors to, collectively, perform a method for monthly revenue commit cost optimization, comprising:
receiving a selection of a retail plan by a customer;
selecting an initial wholesale plan offered by a network operator for use of a network and mapping the initial wholesale plan to the retail plan of the customer;
receiving usage of the network by the customer for a first period of time;
estimating a future monthly usage of the network by the customer;
determining a least-cost wholesale plan for the customer; and
switching the customer from the initial wholesale plan to the least-cost wholesale plan and mapping the least-cost wholesale plan to the retail plan.
